(19) United States
(12) Patent Application Publication
(10) Pub. No.: US 2008/0277516 A1
(43) Pub. Date: Nov. 13, 2008

(54) Fishing reel sideplate

(76) Inventor: John N. Young, Fairfax, VA (US)

Correspondence Address: PACIFIC PRODUCTS, 31 PAMARON WAY, STE. D, NOVATO, CA, 94949, US

(21) Appl. No.: 11/800,664

(22) Filed: May 7, 2007

(51) Int. Cl. A01K 89/00

(52) U.S. Cl. 242/310

(57) ABSTRACT

This invention teaches a simple eccentric reel sideplate design to provide greater sideplate volume in one area than another.

### CROSS-REFERENCE TO RELATED APPLICATIONS

The following references are considered to be relative prior art.
U.S. Pat. No. RE 31,920
U.S. Pat. No. 2,361,239
U.S. Pat. No. 3,968,943
U.S. Pat. No. 3,974,977
U.S. Pat. No. 4,131,245
U.S. Pat. No. 4,421,285
U.S. Pat. No. 4,516,741
U.S. Pat. No. 4,738,410
U.S. Pat. No. 4,742,974
U.S. Pat. No. 4,763,856
U.S. Pat. No. 4,805,849
U.S. Pat. No. 4,813,629
U.S. Pat. No. 4,821,978
U.S. Pat. No. 4,840,327
U.S. Pat. No. 4,919,362
U.S. Pat. No. 5,035,374
U.S. Pat. No. 5,086,991
U.S. Pat. No. 5,069,396
U.S. Pat. No. 5,090,634
U.S. Pat. No. 5,110,066
U.S. Pat. No. 5,150,854
U.S. Pat. No. 5,193,763
U.S. Pat. No. 5,348,247
U.S. Pat. No. 5,607,117
U.S. Pat. No. 5,799,891
U.S. Pat. No. 6,113,019
U.S. Pat. No. 6,364,228
U.S. Pat. No. 6,402,073
U.S. Pat. No. 7,017,845

### STATEMENT REGARDING FEDERALLY SPONSORED RESEARCH OR DEVELOPMENT

Not applicable

### REFERENCE TO SEQUENCE LISTING, TABLE, OR DISK APPENDIX

Not applicable

### BACKGROUND OF THE INVENTION

Fishing reels generally categorized as conventional reels have long had the common features of a center frame enclosing a spool and sideplate covers positioned on either side of the center frame carrying various reel mechanisms including transmission systems to convert handle rotation into spool rotation. Original designs of the sideplates were simple, regular geometric shapes, most commonly circular, that housed the transmission and other internal mechanisms. As these internal systems developed over time they became larger and more complicated, and the sideplates as well became more complex in design to properly house and protect the larger internal mechanisms.

### PURPOSE OF THE INVENTION

It is a purpose of this invention to teach a simpler sideplate design that permits proper housing and protection of larger internal mechanisms.

### BRIEF DESCRIPTION OF THE DRAWINGS

FIG. 1 is an inside elevation view of a prior art conventional reel sideplate assembly showing a simple geometric shape housing standard transmission parts.

FIG. 2 is a cross section of the sideplate assembly of FIG. 1.

FIG. 3 is an inside elevation view of a conventional reel sideplate assembly showing a modified edge detail.

FIG. 4 is a cross section of the reel of FIG. 3.

FIG. 5 is a front elevation view of a circular sideplate illustrating the concentric application of an edge detail to a circular sideplate.

FIG. 6 is a side elevation view of the sideplate of FIG. 5.

FIG. 7 is a front elevation view of the circular sideplate of FIG. 5 illustrating the eccentric application of the edge detail of FIG. 6.

FIG. 8 is a side view of the sideplate of FIG. 7.

FIG. 9 is an inside elevation view of a reel sideplate assembly showing an eccentric edge detail producing a reduced volume sideplate.

FIG. 10 is a cross section of the sideplate of FIG. 9.

FIG. 11 is an outside elevation view of the sideplate of FIG. 9.

FIG. 12 is the side view of the sideplate of FIG. 11.

FIG. 13 is a perspective view of the sideplate of FIG. 11.

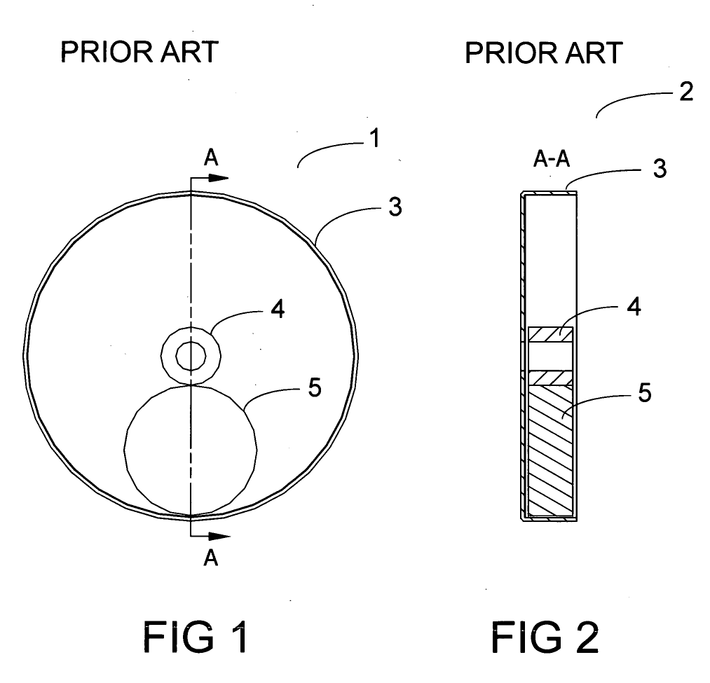

### DETAILED DESCRIPTION OF THE INVENTION

From the inception of conventional reels, enduring design elements have been a pair of sideplate bodies held rigidly apart to support a rotating spool between them. Reference to U.S. Pat. Nos. 2,361,239 and 4,131,245 show this initial construction as well as the characteristic that sideplates function as housings that support transmission systems for converting handle rotation into spool rotation. Referring to the FIG's, a representation of this prior art shows a conventional sideplate housing assembly 1 with sideplate 3 housing a main gear 5 and pinion gear 4. The main gear and pinion gear are common elements of transmission systems which are not claimed and the two gears together shall be considered as a unitary transmission element 13 throughout the following description.

As transmissions developed in size and complexity, so too did their associated sideplate designs become wider and more complex to accommodate the new transmission systems. U.S. Pat. Nos. 4,516,741, 5,090,634 and other patents teach both enlarged transmission systems and a growing size and complexity of the sideplate designs required to house these transmissions.

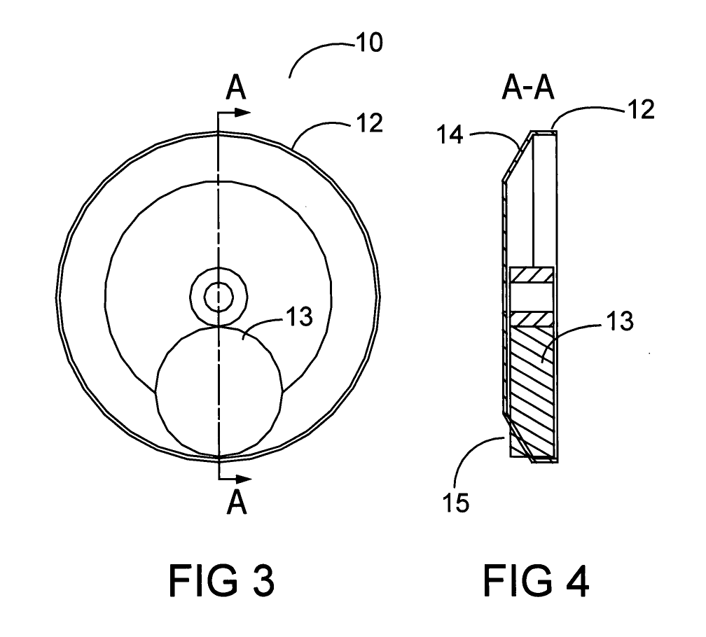

One solution to the larger sideplate designs was to add simple chamfers or fillets to sideplate edges in order to reduce the sideplates' volume. But such solutions still required complex sideplate designs. FIG. 3 and FIG. 4 illustrate the problem associated with adding simple edge chamfers or fillets to sideplates. In FIG. 3 and FIG. 4, sideplate assembly 10 shows sideplate 12 formed to have a concentric chamfered face 14. It can be seen that by adding this chamfer, an area of interference 15 between the transmission and sideplate develops which can only be resolved by either making the sideplate wider or by reverting to a more complex geometry sideplate design.

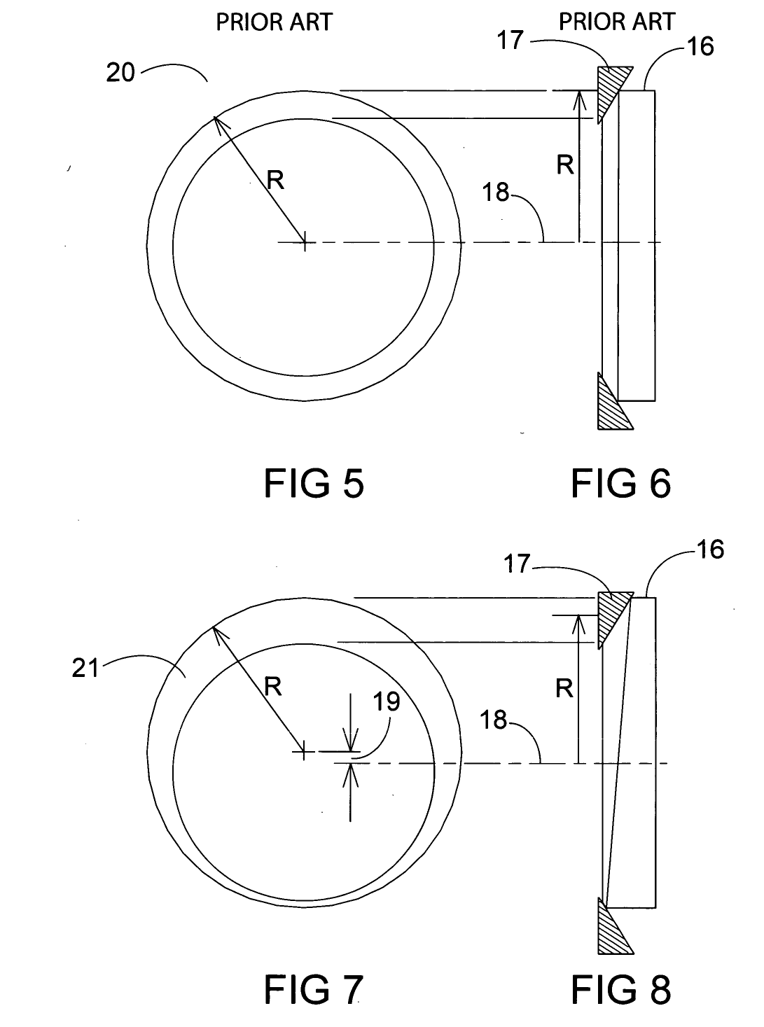

FIGS. 5 and 6 show the concentric application of a simple edge detail 17 to a circular sideplate 16 to yield a reduced volume sideplate 20 wherein the reduced volume is dispersed evenly around the full perimeter of the sideplate.

FIGS. 7 and 8 show the eccentric application of the same simple edge detail 17 to the same circular sideplate 16 with a rotational offset 19 to produce an uneven reduction of sideplate volume 21 around the perimeter of the sideplate.

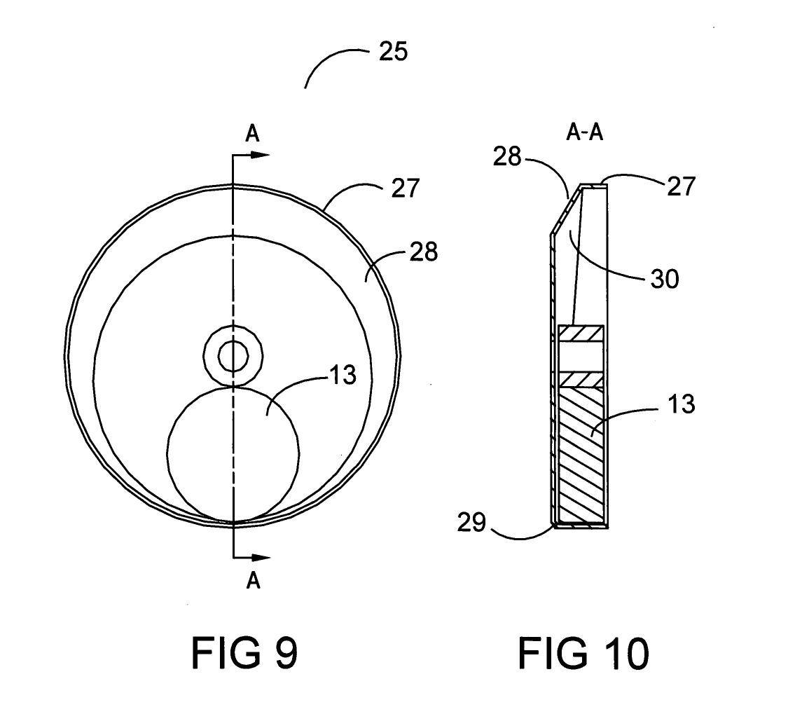

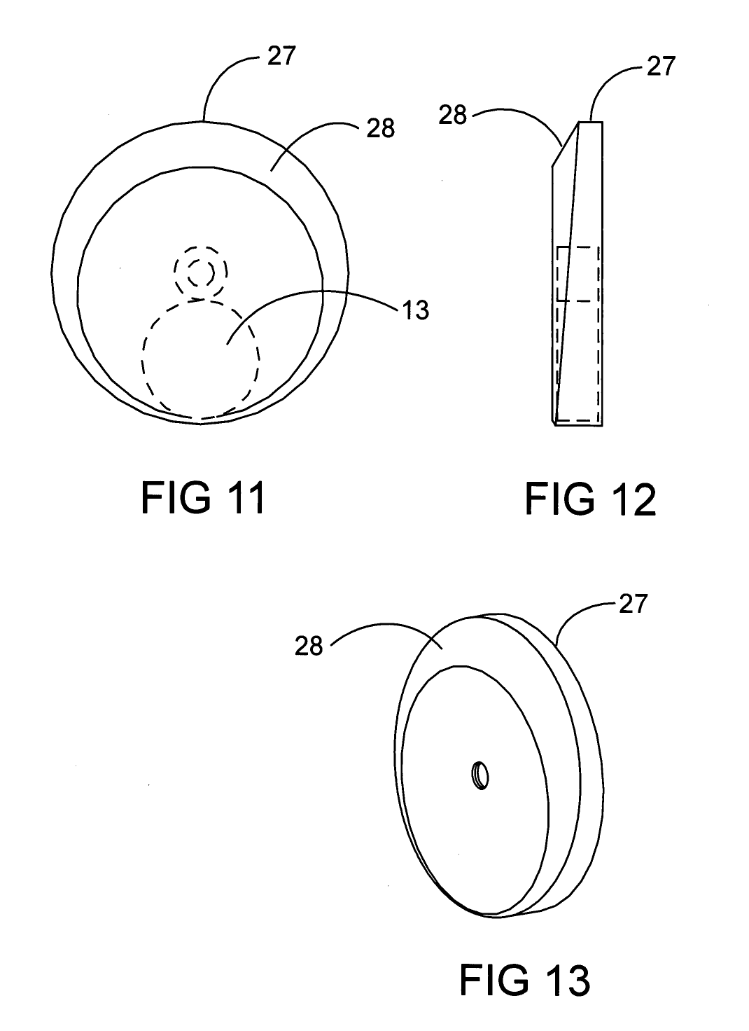

A sideplate design that unevenly removes sideplate volume and avoids interference with transmission elements is illustrated in FIG. 9 through FIG. 13. In these FIG's sideplate 27 is formed with a simple bevel surface 28 wherein the bevel detail's center of rotation is offset from the center of the sideplate's center of rotation so that an eccentric sideplate shape is formed to remove substantial volume from one portion of the sideplate while removing very little volume in another so as to leave enough sideplate volume in the area of the transmission to avoid the FIG. 4 interference problem. It can be seen that the eccentric application of the edge detail provides a substantially reduced sideplate volume 30 where there is are no transmission elements and almost no reduction of sideplate volume in the area 29 where transmission elements are present.

While these illustrations teach a simple bevel or chamfer eccentric edge detail design, it is understood that the edge detail shape may be a bevel, an arc, a radius or many other edge detail shapes.

1. In a reel with a sideplate and a circumferential sideplate edge, an edge shape detail eccentric to the circumferential edge.

2. The reel of claim 1 with a sideplate corner volume in one area greater than in another.

3. In a reel with a sideplate having a geometric primary as its fundamental shape and a circumferential sideplate edge, an edge detail eccentric to the circumferential edge.

4. The reel of claim 3 with a sideplate corner volume in one area greater than in another.

5. In a reel with a circular sideplate shape and a circumferential edge, an edge detail eccentric to the circumferential edge.

6. The reel of claim 5 with a sideplate corner volume greater in one area than another.

7. In a reel with an ovaloid sideplate shape and a circumferential edge, an edge detail, eccentric to the sideplate edge.

8. The reel of claim 7 with a sideplate corner volume greater in one area than another.
